(19) United States
(12) Patent Application Publication
(10) Pub. No.: US 2006/0061580 A1
(43) Pub. Date: Mar. 23, 2006

(54) Display device, content data delivery device and content data delivery system

(76) Inventors: Kohji Fujiwara, Tenri-shi (JP); Tomohiko Yamamoto, Nara-shi (JP)

Correspondence Address: HARNESS, DICKEY & PIERCE, P.L.C., P.O. BOX 8910, RESTON, VA, 20195, US

(21) Appl. No.: 11/230,496

(22) Filed: Sep. 21, 2005

(30) Foreign Application Priority Data
Sep. 21, 2004 (JP) 2004-273913

(51) Int. Cl. G06T 1/60

(52) U.S. Cl. 345/530

(57) ABSTRACT

A display device includes an ID storage section which is a read-only storage and stores a display ID being exclusive to the display device and readable by a computer. An ID judgment section judges whether or not the display device is entitled to reception of content data, based on the display ID read out from the display device. When the display device is authenticated, a communication section of a content data delivery device delivers the content data to the display device. As a result, individual authentication of the display device and selective delivery of the content data to the display device, by the content data delivery device, can be realized. Namely, it is possible to provide the display device, which ensures individual authentication, and to which content data can be selectively delivered.

This non-provisional application claims priority under 35 U.S.C. § 119(a) on Patent Application No. 2004/273913 filed in Japan on Sep. 21, 2004, the entire contents of which are hereby incorporated by reference.

### FIELD OF THE INVENTION

The present invention relates to a display device which ensures individual authentication, a content data delivery device for selectively delivering content data by authenticating the display device, and a content data delivery system which includes the display device and the content data delivery device.

### BACKGROUND OF THE INVENTION

In modern society, a variety of personal information and image information are computerized and are able to be transmitted and received by use of a wide range of communication network such as the Internet. Therefore, in terms of security, it is important to increase conservation of such information and to identify an information terminal used by individual. For this purpose, there have been needs for a system for securely authenticating a user of a terminal, a system for selectively transmitting and receiving information, and a system for delivering a content item suitable for each individual to a specific terminal.

One technology which can be used for such a system is disclosed in Japanese Laid-Open Patent Application 2003/248451 (Tokukai 2003-248451) (published date; Sep. 5, 2003). According to the technology disclosed in this document, a panel controller for controlling display of a display panel reads out a parameter of the display panel from an interface circuit included in the display panel. This panel controller is constituted of a reconfigurable field programmable gate array (FPGA) and the like. The parameter is information indicative of characteristics of the display panel, such as resolution and the number of colors of the display panel.

The panel controller disclosed in the document modifies its functional characteristics based on the parameter read out from the interface circuit. As a result, the function of the panel controller changes to perform suitable display for the display panel.

However, in the device disclosed in the document, the parameter which can be recognized through the interface circuit serves to indicate general information of the display panel rather than to identify individual display panels. Therefore, when the characteristics of a display panel such as resolution and the number of colors are the same among a plurality of display panels, the parameter is also the same among them. It follows that a plurality of display panels have the same parameter.

Namely, identification based on such a parameter does not mean sure identification of individual displays, meaning that the system is not capable of identifying a user of the display panel or of selectively delivering information to the display panel.

A possible solution may be a method for using an IP address, which allows identification of individual terminals. An IP address of 4 bytes, which is referred to as IPv4, is currently used. However, due to explosive increase in the number of Internet users, the number of the IP addresses is currently smaller than the number of the terminal users.

As a result, every time a user accesses the Internet, a different IP address is allotted to the user from a provider. Under such circumstances, the use of the IP address does not function to securely identify individual terminals.

### SUMMARY OF THE INVENTION

The present invention is made in view of the foregoing problems, and its object is to provide a display device that is able to surely perform individual authentication, a content data delivery device for authenticating the display device and selectively delivering content data, and a content data delivery system that includes the display device and the content data delivery device.

In order to solve the problem, the display device of the present invention includes a display device identification data storage section which is a read-only storage and stores display device identification data, the display device identification data being exclusive to the display device and readable by a computer.

The term “display device identification data” here means an identification ID that is allotted to a display device, and exclusive to the display device, namely, the only one ID in the world. Therefore, in the present invention, each of the display devices owns exclusive display device identification data.

Further, the display device identification data is readable by a computer. Therefore, the display device can be individually authenticated by a content data delivery device possible to access the display device, based on the display device identification data. Further, it is possible to individually deliver content data to the display device from the content data delivery device after the content data delivery device has authenticated the display device.

As described above, with the arrangement, the present invention provides the display device ensuring individual authentication and selective delivery of content items.

In order to solve the problem, the content data delivery device of the present invention includes: a display device identification data reading section for reading out display device identification data from a display device identification data storage section included in the display device; a content data delivery judgment section for judging, based on the display device identification data read out by the display device identification data reading section, whether or not the display device, which owns the display device identification data, is entitled to reception of content data; and a content data delivery section for delivering the content data to the display device which has been entitled to reception of the content data by the content data delivery judgment section.

With the arrangement, from the display device to which display device identification data being exclusive to the display device and readable by a computer is allotted, the display device identification data reading section of the content data delivery device reads out the display device identification data. Based on the display device identification data, the content data delivery judgment section judges whether or not the display device is entitled to reception of content data indicative of a content item such as a text, an image, and/or a moving image.

Therefore, when the content data delivery judgment section judges that the display device is entitled to reception of content data, the content data delivery device authenticates the display device. At this time, the content data delivery section of the content data delivery device delivers the content data to the display device.

As shown above, with the arrangement, the present invention provides the content data delivery device that is capable of ensuring authentication of the display device having the display device identification data exclusive to the display device, and of selectively delivering the content data. On this account, this content data delivery device performs highly maintainable and confidential delivery of content data.

Further, the content data delivery system of the present invention is constituted of the display device and the content data delivery device.

With the arrangement, it is possible to provide a content data delivery system in which the content data delivery device performs individual authentication of the display device and selectively delivers content data to the display device.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating an arrangement of a display device according to an embodiment of the present invention.

FIG. 2 is a block diagram illustrating an arrangement of a content delivery system constituted of a display device and a content data delivery device.

FIG. 3 is a block diagram illustrating an arrangement of a display device in which an ID storage section is combined with a display controlling section.

FIG. 4 is a block diagram illustrating an arrangement of a display device in which an ID storage section is formed in a display section.

FIG. 5 is a block diagram illustrating an arrangement of a content delivery system in which a plurality of content data delivery devices perform authentication of a display ID by use of an ID authentication server.

FIG. 6 is a block diagram illustrating an arrangement of a content delivery system for selectively delivering content data by use of an authorized ID database which stores display IDs and personal data items which are respectively associated with each other.

FIG. 7 is a block diagram illustrating an arrangement of a content delivery system for selectively delivering content data by use of an authorized ID database which stores display IDs and previously delivered data items which are respectively associated with each other.

### DESCRIPTION OF THE EMBODIMENTS

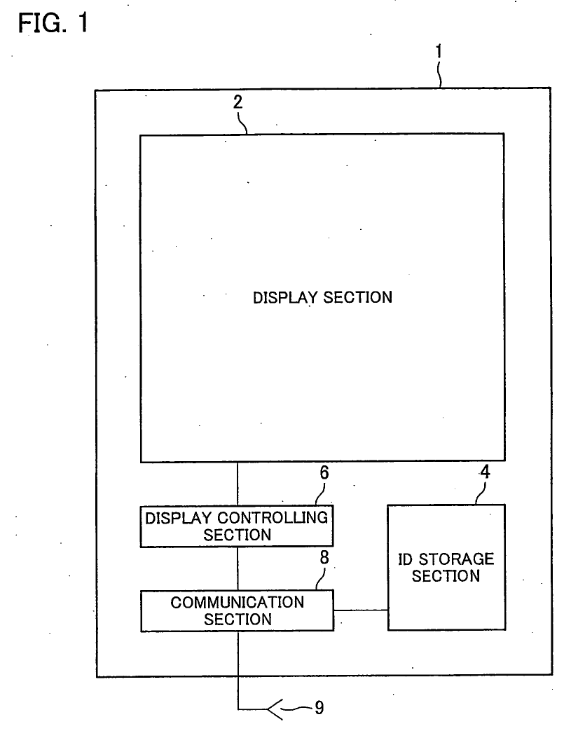

An embodiment of the present invention is explained below with reference to FIGS. 1 through 7.

FIG. 1 is a block diagram illustrating an arrangement of a display device 1 according to an embodiment of the present invention. According to FIG. 1, the display device 1 includes a display section 2, an ID storage section 4 (a display device identification data storage section), a display controlling section 6, a communication section 8, and a wireless antenna 9.

The display section 2 is general display means having a TFT (Thin Film Transistor) element and the like. In the present embodiment, this display section 2 is a liquid crystal display panel.

The ID storage section 4 is a read-only device, and is constituted of, for example, ROM (Read Only Memory), FPGA (Field Programmable Gate Array), PLD (Programmable Logic Device) and the like.

The ID storage section 4 stores a display ID (a display device identification data) exclusively provided to the display device 1. The display ID is readable by a computer. The term “exclusively” here means that it is only one in the world. Therefore, each display device 1 is given an exclusive display ID, which is only one in the world.

The display controlling section 6 controls display of a content item (such as a text, an image and/or a moving image) in the display section 2. Namely, the display controlling section 6 is supplied with content data received by the communication section 8 and displays a content item represented by this content data in the display section 2.

The communication section 8 transmits and receives data using a wireless communication. More specifically, the communication section 8 receives the content data transmitted from a later mentioned content data delivery device 10, and outputs the received content data to the display controlling section 6. Further, the communication section 8 reads out the display ID from the ID storage section 4 according to a request from the content data delivery device 10, and transmits the display ID to the content data delivery device 10.

The wireless antenna 9 is an antenna for transmitting and receiving a wireless signal.

The display device 1 illustrated in FIG. 1 has a minimum structure as a display device. The “minimum structure” here means a structure that is necessary and sufficient for displaying the content item represented by the received content data. Namely, the display device 1 has a structure that is specialized in a display function for receiving content data and displaying a content item represented by the content data. In this sense, it is necessary to provide a content item to be displayed for the display device 1 from other device.

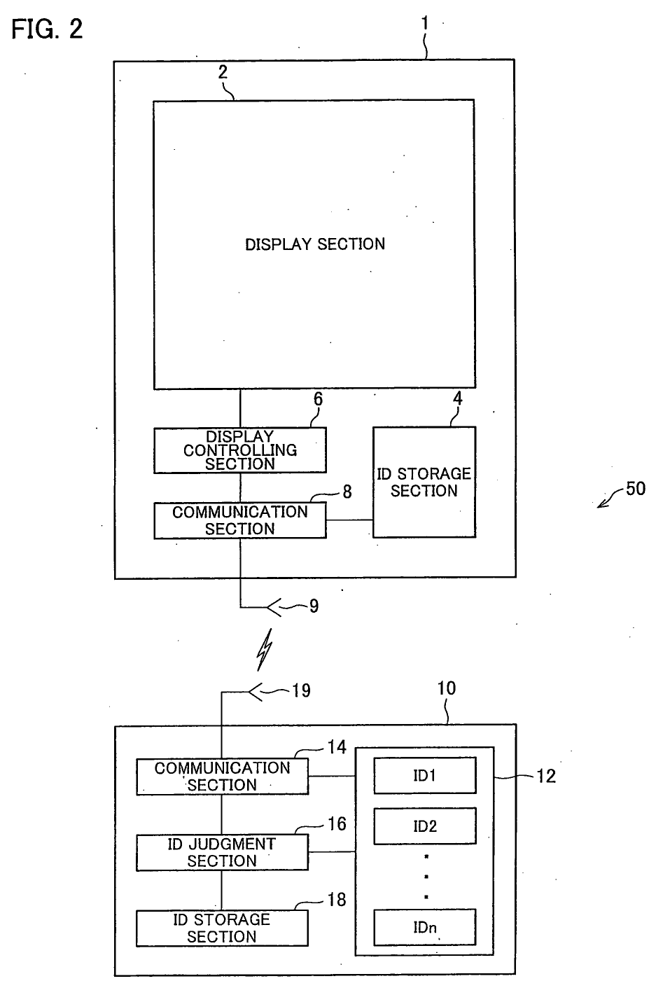

In the present embodiment, the content data delivery device 10 illustrated in FIG. 2 serves as a provider of content data. Namely, the display device 1 and the content data delivery device 10 constitute a content delivery system 50 for selectively delivering content data and displaying a content item represented by the content data.

In the content delivery system 50, the display device 1 and the content data delivery device 10 constitute a client/server system. Namely, the display device 1 is operated by a user by use of input means (not shown in figures). Then, the display device 1 transmits an instruction from the user to the content data delivery device 10, and the content data delivery device 10 carries out processing according to the instruction, and sends back a result of the processing to the display device 1. In this way, the display device 1 becomes capable of displaying a content item with no circuit or a processor for performing complicated image processing.

The content delivery system 50 is explained below with reference to FIG. 2.

FIG. 2 is a block diagram illustrating an arrangement of content delivery system 50 that is constituted of the display device 1 and the content data delivery device 10. According to FIG. 2, the content delivery system 50 includes the display device 1 and the content data delivery device 10. Here, as illustrated in FIG. 2, the content data delivery device 10 includes an authorized ID database 12, a communication section 14 (content data delivery means, display device identification data reading means), an ID judgment section 16 (content data delivery judgment means, delivery device identification data reading means), an ID storage section 18 (a delivery device identification data storage section), and a wireless antenna 19.

The authorized ID database 12 stores display IDs allotted to display devices 1 subjected to reception of content data. By referring to this authorized ID database 12, the later-mentioned ID judgment section 16 performs authentication of the display device 1.

The communication section 14 transmits and receives data using a wireless communication. More specifically, the communication section 14 transmits to the display device 1 content data, as well as a controlling signal for requesting transmission of the display ID owned by the display device 1 (the display ID stored in the ID storage section 4 of the display device 1). Further, the communication section 14 receives the display ID transmitted from the display device 1. By a series of these processes, the communication section 14 reads out the display ID from the ID storage section 4 of the display device 1. The communication section 14 outputs the received display ID to the ID judgment section 16.

The ID judgment section 16 judges whether the display ID of the display device 1, which is received by the communication section 14, exists in the authorized ID database 12. At this time, the ID judgment section 16 judges based on the authorized ID database 12. Namely, when the display ID is stored in the authorized ID database 12, the ID judgment section 16 informs the communication section 14 of authorizing transmission of content data to the display device 1. On the other hand, when the display ID is not stored in the authorized ID database 12, the ID judgment section 16 informs the communication section 14 of rejecting transmission of content data to the display device 1.

The ID storage section 18 is a read-only device as with the ID storage section 4. This ID storage section 18 stores a delivery device ID (delivery device identification data) exclusively provided to the content data delivery device 10 (a delivery device end) and readable by a computer. The term “exclusively” here means that it is only one in the world. Therefore, each content data delivery device 10 is given an exclusive delivery device ID, which is only one in the world.

By use of the display ID and the delivery device ID, one-to-one (pier-to-pier) content data delivery is ensured between the content data delivery device 10 and the display device 1.

The wireless antenna 19 is an antenna for transmitting and receiving a wireless signal as with the wireless antenna 9.

In the content delivery system 50, the content data delivery device 10 authenticates the display device 1 and selectively delivers content data to the display device 1. A flow of this process is explained below.

First, the user of the display device 1 comes into a range in which the display device 1 can communicate with the content data delivery device 10. Then, the communication section 14 of the content data delivery device 10 transmits to the display device 1 a signal for requesting transmission of the display ID via the wireless antenna 19. This request signal is received by the communication section 8 of the display device 1. After reception of the request signal, the communication section 8 accesses the ID storage section 4 and reads out the display ID. Then, the communication section 8 transmits this display ID to the content data delivery device 10 via the wireless antenna 9.

The display ID transmitted by the communication section 8 is received by the communication section 14 of the content data delivery device 10. The communication section 14 outputs the received display ID to the ID judgment section 16. After reception of the display ID, the ID judgment section 16 accesses the authorized ID database 12, and judges whether the display ID transmitted from the display device 1 exists in the authorized ID database 12.

When the display ID is found in the authorized ID database 12, the ID judgment section 16 outputs a content data delivery authorization signal to the communication section 14. After reception of this signal, the communication section 14 starts delivering content data to the display device 1.

In the display device 1, the communication section 8 receives the delivered content data. The communication section 8 outputs the received content data to the display controlling section 6. Based on the received content data, the display controlling section 6 displays, in the display section 2, a content item represented by the content data, constituted of a text, an image and/or a moving image.

With the above process, in the content delivery system 50, the display device 1 having the display ID registered (stored) in the authorized ID database 12 of the content data delivery device 10 is individually authenticated by the content data delivery device 10, and content data is selectively delivered from the content data delivery device 10 to the authenticated display device 1. Consequently, a content item is displayed on the display device 1 authenticated by the content data delivery device 10.

On the other hand, when the display device 1 has a display ID that is not registered (stored) in the authorized ID database 12 of the content data delivery device 10, the display device 1 is not authenticated by the content data delivery device 10. Therefore, the content data delivery device 10 does not deliver the content data to the display device 1. With this arrangement, the content item is not displayed on the display device 1 that is not authenticated by the content data delivery device 10.

As described above, in the content delivery system 50, content data is delivered only to the display device 1 authenticated by the content data delivery device 10. In other words, content data is not delivered to the display device 1 not granted for reception of content data from the content data delivery device 10. On this account, conservation of delivered content data is increased.

Note that, the content data delivery device 10 may perform one-to-one authentication for the display device 1 using the delivery device ID stored in the ID storage section 18. In this case, the ID judgment section 16 of the content data delivery device 10 reads out the delivery device ID from the ID storage section 18, and the content data delivery device 10 determines whether or not the display device 1 is entitled to reception of content data from the delivery device 10, depending on the combination of the display ID transmitted from the display device 1 and the delivery device ID read out from the ID storage section 18.

To perform such a one-to-one authentication, the ID judgment section 16 refers to another ID authentication data base (not shown in figures) which stores information about association of the display ID and the delivery device ID. When the same association is registered in this database, the ID judgment section 16 judges that it is valid to deliver content data to the display device 1, and outputs a content data delivery authorization signal.

By thus performing one-to-one authentication between a particular display device 1 and a particular content data delivery device 10, highly maintainable and confidential content data is delivered to the display device 1 from the content data delivery device 10 having the delivery device ID.

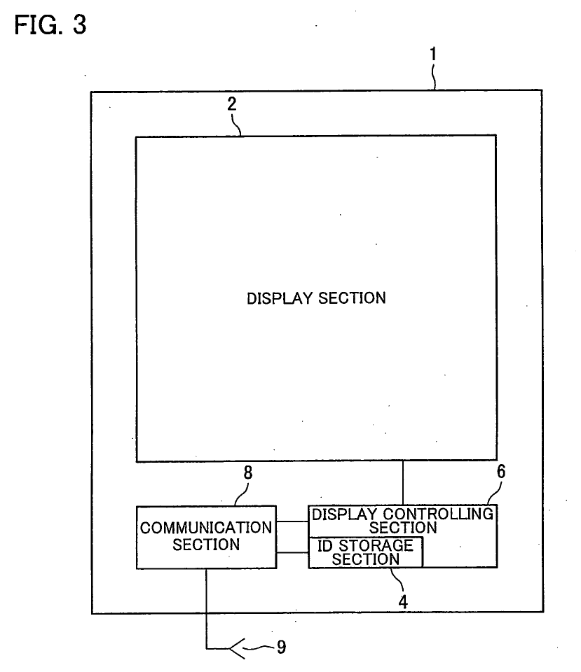

The arrangement of the display device 1 constituting the content delivery system 50 is not limited to the one illustrated in FIG. 1, and its hardware structure may have other optional functions. The following describes the first example of additional functions with reference to FIG. 3.

FIG. 3 is a block diagram illustrating an arrangement of a display device 1 in which an ID storage section 4 is combined with a display controlling section 6. As shown herein, the ID storage section 4 is combined with the display controlling section 6 in this display device 1. Here, the display controlling section 6 combined with the ID storage section 4 is a read-only device such as FPGA and PLD, in other words, a non-writable device.

This arrangement in which the ID storage section 4 is combined with the display controlling section 6 requires less number of components and a smaller area of a chip, compared with an arrangement in which the ID storage section 4 is separate from the display controlling section 6, thus reducing the total size of the display device 1. Further, a cost for fabricating the display device 1 can be reduced.

Note that, with the display device 1 illustrated in FIG. 3, the content delivery system 50 is (of course) still capable of the user authentication using the display ID (individual authentication of the display device 1) and the selective delivery of content data.

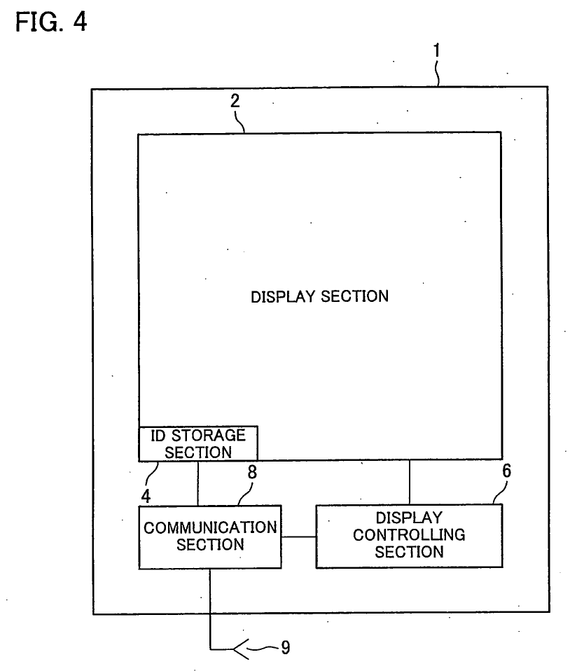

The following describes the second example of additional function with reference to FIG. 4.

FIG. 4 is a block diagram illustrating an arrangement of a display device 1 in which an ID storage section 4 is formed in the display section 2. In the display device 1 illustrated in FIG. 4, the ID storage section 4 is formed so as to be combined with the display section 2. Namely, the ID storage section 4 is included in the display section 2. Here, the ID storage section 4 is formed in an arbitrary one of constituting parts of the display section 2 in an arbitrary form. For example, the ID storage section 4 may be directly formed on a glass substrate of the display section 2 by a semiconductor technology using a serial crystal grain silicon (CG silicon, CGS). Further, such a direct forming can be realized by use of LPS (Low Temperature Poly Silicon TFT).

In all of these cases, the ID storage section 4 is directly formed in the display section 2. Therefore, in the arrangement, the number of parts is further reduced, and an area of a chip is further minified compared with an arrangement in which the ID storage section 4 is separate from the display section 2 or an arrangement in which the ID storage section 4 is combined with the display controlling section 6. Further, the total size of the display device 1 is reduced, ensuring further cost reduction in fabricating the display device 1.

Note that, with the display device 1 illustrated in FIG. 4, the content delivery system 50 is (of course) still capable of the user authentication using the display ID (individual authentication of the display device 1) and the selective delivery of content data.

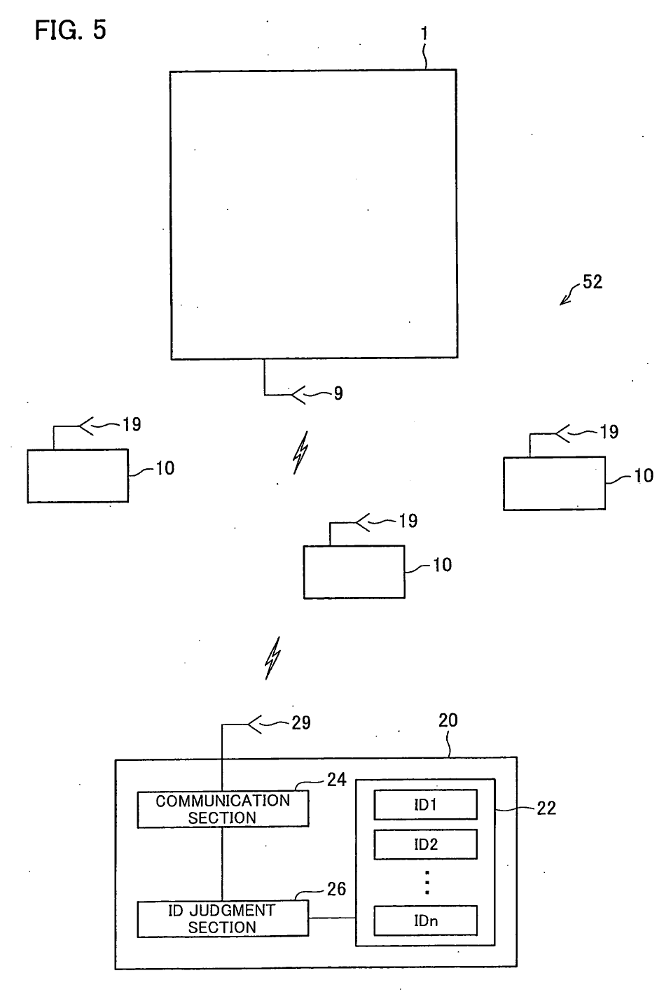

The foregoing content data delivery system made up of the display device 1 and the content data delivery device 10 is not limited to the arrangement of content delivery system 50 illustrated in FIG. 2, which has a single display device 1 and a single content data delivery device 10. For example, the content data delivery system may have an arrangement in which a plurality of content data delivery devices 10 are provided with respect to a single display device 1 and vice versa. The following describes a content delivery system 52 having an arrangement in which a plurality of content data delivery devices 10 deliver content data to a single display device 1, with reference to FIG. 5.

FIG. 5 is a block diagram illustrating an arrangement of the content delivery system 52 in which a plurality of the content data delivery devices 10 perform authentication of display IDs using an ID authentication server 20. According to FIG. 5, the content delivery system 52 includes one display device 1, three content data delivery devices 10, and one ID authentication server 20. This display device 1 has one of the arrangements illustrated in FIGS. 1, 3 and 4. The arrangement of this content data delivery device 10 is different from the arrangement illustrated in FIG. 2, and does not have an ID judgment section 16 and an authorized ID database 12 necessary for authentication of a display ID. Therefore, the content data delivery devices 10 in this example do not perform the authentication of a display ID.

In the content delivery system 52, instead of the content data delivery device 10, the ID authentication server 20 performs the authentication of a display ID. As illustrated in FIG. 5, this ID authentication server 20 includes an authorized ID database 22, a communication section 24, an ID judgment section 26, and a wireless antenna 29.

The authorized ID database 22, the ID judgment section 26 and the wireless antenna 29 have the same functions as those of the authorized ID database 12, the ID judgment section 16 and the wireless antenna 19, respectively, and explanations thereof are omitted here. The communication section 24 receives the display ID of the display device 1 transmitted from the content data delivery device 10. Further, the communication section 24 transmits a content data delivery authorization signal to the content data delivery device 10.

A flow of an authentication process of the display device 1 in the content delivery system 52 is explained below.

In this example, the process is the same as that of the content delivery system 50 illustrated in FIG. 2 until the content data delivery device 10 transmits a request signal for requesting a display ID to the display device 1 and receives the display ID transmitted from the display device 1.

After that, the communication section 14 of the content data delivery device 10 transmits the received display ID to the ID authentication server 20. In the ID authentication server 20, the communication section 24 receives the display ID transmitted from the communication section 14. After reception of the display ID, the communication section 24 outputs the display ID to the ID judgment section 26. After reception of the display ID, the ID judgment section 26 accesses the authorized ID database 22 and judges whether or not the display ID transmitted from the communication section 14, that is, the display ID transmitted from the display device 1 is stored in the authorized ID database 22.

Here, when the judgment found that the display ID is stored in the authorized ID database 22, the ID judgment section 26 outputs the content data delivery authorization signal to the communication section 24. The communication section 24 transmits the received content data delivery authorization signal to the content data delivery device 10.

In the content data delivery device 10, the communication section 14 receives the content data delivery authorization signal. Then, the communication section 14 starts delivery of content data to the display device 1. After that, as with the content delivery system 50 illustrated in FIG. 2, the delivered content item is displayed on the display section 2 of the display device 1.

In this way, in the content delivery system 52, the display devices 1 having the display ID registered (stored) in the authorized ID database 22 of the ID authentication server 20 are individually authenticated by the ID authentication server 20, based on their display ID. And content data is selectively delivered from the content data delivery device 10 to the authenticated display device 1. As a result, a content item is displayed on the display device 1 authenticated by the ID authentication server 20.

On the other hand, when the display device 1 has a display ID that is not registered (stored) in the authorized ID database 22 of the ID authentication server 20, the display device 1 is not authenticated by the ID authentication server 20. Therefore, content data is not delivered from the content data delivery device 10 to the display device 1, meaning that a content item is not displayed on the display device 1 not authenticated by the ID authentication server 20.

As described above, in the content delivery system 52, content data is delivered only to the display device 1 authenticated by the ID authentication server 20. Namely, the content data is not delivered to the display device 1 not entitled to reception of content data from the content data delivery device 10, thereby increasing conservation of delivered information.

Further, in this content delivery system 52, it is unnecessary to provide a separate authorized ID database 12 for each of the three content data delivery devices 10, and therefore the number of parts for constituting hardware of each content data delivery device 10 is further reduced. Accordingly, when a large number of content data delivery devices 10 are provided, further greater cost reduction is expected. Moreover, since the authorized display IDs are managed together in the ID authentication server 20, a list of display IDs to be authorized is more securely and rapidly updated.

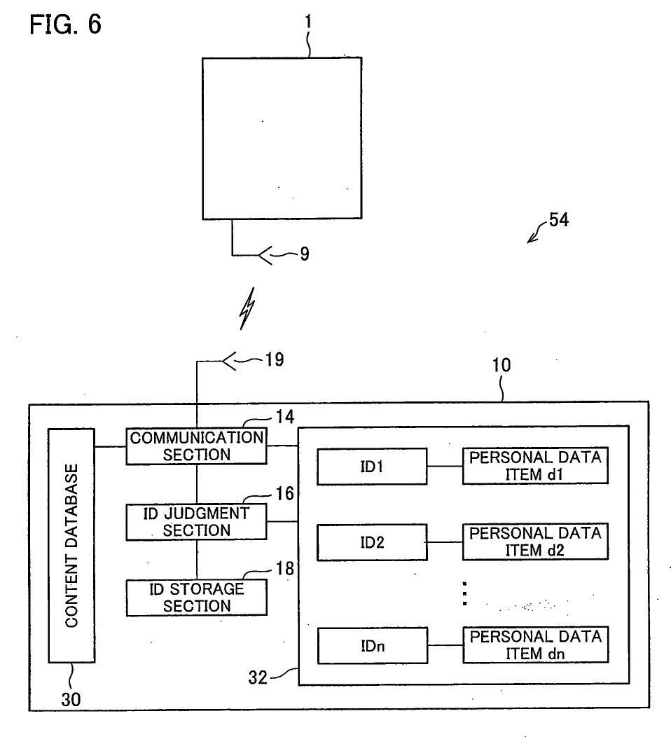

The system of the present invention may be arranged so that delivery of content data is performed in reference to personal data of the user of the display device 1 having an authorized display ID, thereby delivering content data meeting the demand and taste of the user of the display device 1. A content delivery system 54 having this arrangement is explained below with reference to FIG. 6.

FIG. 6 is a block diagram illustrating an arrangement of a content delivery system 54 for selectively delivering content data by use of an authorized ID database which stores display IDs and personal data items which are respectively associated with each other. The content data delivery device 10 constituting the content delivery system 54 illustrated in FIG. 6 includes a content database 30 and an authorized ID database 32, instead of the authorized ID database 12.

The content database 30 stores content data to be delivered to the display device 1.

The authorized ID database 32 stores the display ID of the display device 1 entitled to reception of content data, as well as personal information of the user of the display device 1 having the display ID, so that the display ID and the personal information are related to each other. As illustrated in FIG. 6, the authorized ID database 32 stores display IDs 1 through n (n is an integer not less than 2, and n personal data items d1 through dn that are respectively associated with these display IDs.

The term “personal information” here refers to information items exclusive to each user, such as user's sexuality, occupation, age, and preference of content items.

These information items are registered beforehand in the content data delivery device 10 by a user who asks for delivery of content data to the display device 1 through a user registration process or the like.

In this content delivery system 54, the display device 1 is provided with content data indicative of a particular content item selected based on personal information of the user. Such a selective delivery of content data based on personal information in the content delivery system 54 is more minutely explained below.

The process is the same as that of the content delivery system 50 illustrated in FIG. 2 until the content data delivery device 10 transmits a request signal for requesting a display ID to the display device 1 and receives the display ID transmitted from the display device 1.

After that, the communication section 14 of the content data delivery device 10 outputs the received display ID to the ID judgment section 16. Then, the ID judgment section 16 judges whether the received display ID is registered (stored) in the authorized ID database 32 or not. When the judgment found that the display ID is stored in the authorized ID database 32, the ID judgment section 16 outputs the content data delivery authorization signal to the communication section 14, accesses the authorized ID database 32, reads out personal information related to the authorized display ID, and outputs the personal information to the communication section 14.

Based on the received personal data, the communication section 14 selects, from the content database 30, content data to be delivered to the display device 1 having the display ID, and reads out the suitable content data. For example, if the communication section 14 picks up information that the user of the display device 1 corresponding to the authorized display ID is a movie fan, from the personal information related to this display ID, the communication section 14 reads out content data regarding a movie content item from the content database 30, and transmits the content data to the display device 1.

As a result, the movie content item is delivered to and displayed on the display device 1 of the film-loving user, without user's instruction for specifying movie content items.

As described above, the content delivery system 54 is capable of selectively delivering a content item in accordance with preference of the user to the display device 1.

Further, in the content data delivery system 54, the user carries the display device 1 around, and the display device 1 receives delivery of content data from the plural content data delivery devices 10 provided in various places. Namely, in the content data delivery system 54, each user deals with a single display device 1, but may deal with plural content data delivery devices 10. For this reason, in the content delivery system 54, the display ID of the display device 1 and the personal data of the user are associated to each other. By thus determining content data to be delivered to the display device 1 based on the personal data, delivery of content data can be performed according to user's preference.

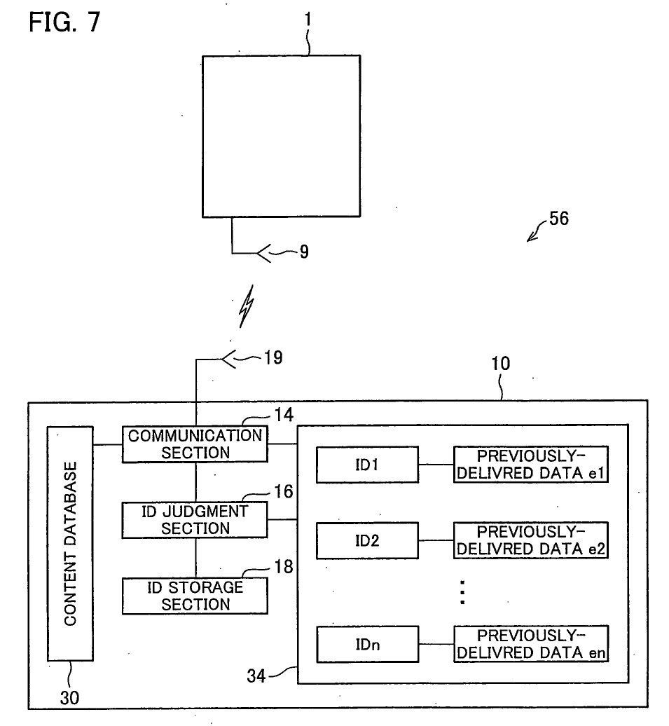

Further, the system of the present invention may be arranged so that, based on content data previously delivered to the user, new content data relative to the previously delivered data is selected and delivered to the user. The following explains a content delivery system 56 with such an arrangement, with reference to FIG. 7.

FIG. 7 is a block diagram illustrating an arrangement of a content delivery system 56 for selectively delivering content data by use of an authorized ID database 34 which stores display IDs and previously delivered data items which are respectively associated with each other. A content data delivery device 10 constituting the content delivery system 56 illustrated in FIG. 7 includes the authorized ID database 34, instead of the authorized ID database 12. Further, the content delivery system 56 includes the content database 30 as with the content delivery system 54.

The authorized ID database 34 stores display IDs for authorizing delivery of content data, and various data items (such as an animation, a movie, and a sports program) that are previously delivered to the display device 1 having the registered display ID, so that the display ID and the previously delivered data are associated with each other. Namely, as illustrated in FIG. 7, the authorized ID database 34 stores display IDs 1 through n (the number of authorized display IDs is n), and previously delivered data items e1 through en (the number of previously delivered data items is n) that are respectively connected with these display IDs. These previously delivered data items are delivered by the communication section 14 to the display device 1, and are respectively associated with the display IDs when stored into the authorized ID database 34.

This content delivery system 56 selects content data likely to be requested by the user, for example, content data indicative of a content item relative to previously delivered content items. This selective delivery of content data based on previously delivered data by the content delivery system 56 is specifically explained below.

The process is the same as that of the content delivery system 50 illustrated in FIG. 2 until the content data delivery device 10 transmits a request signal for requesting a display ID to the display device 1 and receives the display ID transmitted from the display device 1.

After that, the communication section 14 of the content data delivery device 10 outputs the received display ID to the ID judgment section 16. The ID judgment section 16 judges whether or not the received display ID is registered (stored) in the authorized ID database 34. When the display ID is judged to be stored in the authorized ID database 34, the ID judgment section 16 outputs a content data delivery authorization signal to the communication section 14, and at the same time accesses the authorized ID database 34, reads out previously delivered data related to the authorized display ID, and outputs the previously delivered data to the communication section 14. At the time, the display ID transmitted from the display device 1 is authenticated.

Based on the previously delivered data, the communication section 14 selects suitable content data for the display device 1 having the authenticated display ID, and reads out the content data from the database. For example, if the communication section 14 picks up information that movie content items have been frequently delivered to the user of a display device 1 having the authenticated display ID, with reference to the history of previously delivered data associated with the authenticated display ID, the communication section 14 reads out content data regarding pamphlets of new movies, and transmits the content data to the display device 1.

In this case, the content data regarding the pamphlets of new movies is delivered to the user who has often chosen movies. Namely, even without user's instruction for specifying information, the display device 1 receives and displays content data related to the content item which the user has browsed in the past, allowing the content distributor using the content data delivery device 10 to selectively deliver content data in accordance with the user's preferences.

Moreover, since the user receives a content item selected based on his/her preference, the user is likely to browse the delivered content item. For example, when content data indicative of some kind of advertising information is delivered, an advertisement meeting user's need is delivered, and therefore the user is more likely to respond.

Further, the content delivery system 56 does not use personal data of the user, unlike the content delivery system 54. Therefore, there is no possibility of a leakage of personal data.

Note that the present invention is not limited to the embodiments, and a variety of modifications are possible within the range of below-indicated claims. Namely, embodiments obtained by combining technical means suitably modified within the range of the claims are also within the technical scope of the present invention.

For example, the display device 2 is not limited to a liquid crystal display device, and may be a variety of display devices such as a plasma display device and an organic EL display device.

Further, the ID storage section 4 may be arranged so as to include an interface for external communication. In this case, the content data delivery device 10 directly reads out the display ID through the interface of the ID storage section 4, without using the communication section 8.

Further, the content delivery system 50 may be arranged so that content data is firstly transmitted to the display device 1 and, after authentication of the display device 1 based on the display ID is completed, a content item represented by the content data is displayed on the display section 2. The same manner applied to other systems of the embodiments.

Further, in the present invention, the display device 1 may be arranged so as to actively output a signal for requesting authentication of the display device 1 to the content data delivery device 10, instead of waiting authentication from the content data delivery device 10. Further, the display device 1 may be arranged so that while the display device 1 does not receive a display ID requesting signal from the content data delivery device 10, a power source is turned off, and when the display device 1 receives the display ID requesting signal, the power source is automatically turned on.

Further, communication between the content data delivery device 10 and the display device 1 is carried out by use of an arbitrary wireless or wired communication. For example, the communication between the content data delivery device 10 and the display device 1 is carried out by use of wired communication means such as IEEE 1394, USB, a power-line carrier, a cable TV line, a telephone line, an ADSL line, or wireless communication means such as an infrared ray (e.g. IrDA or a remote control), Bluetooth, 802.11 wireless, HDR, a portable phone network, a satellite connection, or a terrestrial digital network.

Further, it is preferable that the display device of the present invention includes the display device identification data storage section in the display panel.

With the arrangement, the display device identification data storage section is formed, for example, on a glass substrate in the display panel, by use of, for example, a semiconductor fabrication technology. As a result, the display device identification data storage section and the display panel are formed in the display device so that the display device identification data storage section and the display panel are combined with each other. Therefore, in the arrangement, the number of parts is further reduced, compared with an arrangement in which the display device identification data storage section is separate from the display panel. Further, an area of a chip is minified, so that the total size of the display device is reduced, ensuring further cost reduction in fabricating the display device.

Further, it is preferable that the content data delivery device of the present invention further includes: a delivery device identification data storage section which is a read-only storage and stores delivery device identification data, the delivery device identification data being exclusive to the delivery device and readable by a computer; and a delivery device identification data reading section for reading out the delivery device identification data from the delivery device identification data storage section, wherein: the content data delivery judgment section judges whether or not the display device, which owns the display device identification data, is entitled to reception of the content data, based on the display device identification data read out by the display device identification data reading section, and on the delivery device identification data read out by the delivery device identification data reading section.

With the arrangement, the content data delivery device performs individual authentication of the display device and selective delivery of the content data, based on the display device identification data and the delivery device identification data. Namely, the content data delivery device can perform delivery of content data to the display device, based on one-to-one individual authentication. As a result, the content data delivery device with the arrangement can deliver highly maintainable and confidential content data to the display device.

Further, it is preferable that the content data delivery device of the present invention further includes: a personal data storage section for storing the display device identification data of the display device and personal data regarding a user of the display device so that the display device identification data and the personal data are related to each other; and a personal data reading section for reading out the personal data, based on the display device identification data read out by the display device identification data reading section, wherein: the content data delivery section selects content data suitable for the user, based on the personal data read out by the personal data reading section, and delivers the content data to the display device.

With the arrangement, selective delivery of the content data, based on the personal data of the user of the display device, is performed from the content data delivery device to the display device. As a result, the user receives a content item selected according to the user's personal information (such as age, sexuality, and likes and tastes of content items). Namely, it is possible to provide a content data delivery device for effectively delivering to the user content data meeting user's demand.

Further, it is preferable that the content data delivery device of the present invention further includes: a previously delivered data storage section for storing the display device identification data of the display device and previously delivered data that has been delivered by the content data delivery section to the display device so that the display device identification data and the previously delivered data are related to each other; and a previously delivered data reading section for reading out the previously delivered data from the previously delivered data storage section, based on the display device identification data read out by the display device identification data reading section, wherein: the content data delivery section selects content data suitable for the user, based on the previously delivered data read out by the previously delivered data reading section, and delivers the content data to the display device.

With the arrangement, based on history of delivered data, that is, the data having been delivered to the display device in the past, the content data suitable for the user is delivered from the content data delivery device to the display device. As a result, content data relative to the content items previously browsed by the user is delivered to the user. Namely, the present invention provides a content data delivery device for effectively delivering to the user content data meeting user's demand.

As described above, the display device according to the present invention includes the display device identification data storage section for storing display device identification data exclusive to the display device, so that the display device can be securely authenticated according to the display device identification data, and content data is selectively delivered to the display device.

The present invention is useful for a variety of display devices such as a liquid crystal display device, a plasma display device, or an organic EL display device. Further, the present invention is useful for a content data delivery device which carries out authentication of the display device to selectively deliver content data. Further, the present invention is useful for a content data delivery system constituted of the display device and the content data delivery device.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A display device comprising a display device identification data storage section, which is a read-only storage and stores display device identification data, the display device identification data being exclusive to the display device and readable by a computer.

2. The display device as set forth in claim 1, comprising the display device identification data storage section in a display panel.

3. The display device as set forth in claim 2, wherein the display device identification data storage section is formed on a glass substrate in the display panel.

4. The display device as set forth in claim 3, wherein the display device identification data storage section is formed of a serial crystal grain silicon.

5. The display device as set forth in claim 1, wherein the display device identification data storage section is combined with a display controlling section for controlling display of a content item on a display panel.

6. The display device as set forth in claim 1, the display device being a liquid crystal display device.

7. The display device as set forth in claim 1, wherein the display device identification data storage section includes an interface for external communication.

8. A content data delivery device, comprising:
display device identification data reading means for reading out display device identification data from a display device identification data storage section, which is a read-only storage included in a display device and stores the display device identification data, the display device identification data being exclusive to the display device and readable by a computer;
content data delivery judgment means for judging, based on the display device identification data read out by the display device identification data reading means, whether or not the display device, which owns the display device identification data, is entitled to reception of content data; and
content data delivery means for delivering the content data to the display device which has been entitled to reception of the content data by the content data delivery judgment means.

9. The content data delivery device as set forth in claim 8, further comprising:
a delivery device identification data storage section which is a read-only storage and stores delivery device identification data, the delivery device identification data being exclusive to the delivery device and readable by a computer; and
delivery device identification data reading means for reading out the delivery device identification data from the delivery device identification data storage section,
wherein:
the content data delivery judgment means judges whether or not the display device, which owns the display device identification data, is entitled to reception of the content data, based on the display device identification data read out by the display device identification data reading means, and on the delivery device identification data read out by the delivery device identification data reading means.

10. The content data delivery device as set forth in claim 8, further comprising:
a personal data storage section for storing the display device identification data of the display device and personal data regarding a user of the display device so that the display device identification data and the personal data are related to each other; and
personal data reading means for reading out the personal data, based on the display device identification data read out by the display device identification data reading means,
wherein:
the content data delivery means selects content data suitable for the user, based on the personal data read out by the personal data reading means, and delivers the content data to the display device.

11. The content data delivery device as set forth in claim 8, further comprising:
a previously delivered data storage section for storing the display device identification data of the display device and previously delivered data that has been delivered by the content data delivery means to the display device so that the display device identification data and the previously delivered data are related to each other; and
previously delivered data reading means for reading out the previously delivered data from the previously delivered data storage section, based on the display device identification data read out by the display device identification data reading means,
wherein:
the content data delivery means selects content data suitable for the user, based on the previously delivered data read out by the previously delivered data reading means, and delivers the content data to the display device.

12. A content data delivery system comprising a display device and a content data delivery device, wherein
the display device includes a display device identification data storage section which is a read-only storage and stores display device identification data, the display device identification data being exclusive to the display device and readable by a computer, and
the content data delivery device includes:
display device identification data reading means for reading out the display device identification data from the display device identification data storage section;
content data delivery judgment means for judging whether or not the display device, which owns the display device identification data, is entitled to reception of content data, based on the display device identification data read out by the display device identification data reading means; and
content data delivery means for delivering the content data to the display device which has been entitled to reception of the content data by the content data delivery judgment means.
